(19) United States
(12) Patent Application Publication
(10) Pub. No.: US 2025/0106752 A1
(43) Pub. Date: Mar. 27, 2025

(54) COMMUNICATIONS DEVICE, RELAY COMMUNICATIONS NODE, INFRASTRUCTURE EQUIPMENT AND METHODS

(71) Applicant: Sony Group Corporation, Tokyo (JP)

(72) Inventors: Yuxin WEI, Basingstoke (GB); Vivek SHARMA, Basingstoke (GB); Hideji WAKABAYASHI, Basingstoke (GB); Yassin Aden AWAD, Basingstoke (GB)

(73) Assignee: Sony Group Corporation, Tokyo (JP)

(21) Appl. No.: 18/291,249

(22) PCT Filed: Jul. 18, 2022
(86) PCT No.: PCT/EP2022/070079

§ 371 Date: Jan. 23, 2024

(30) Foreign Application Priority Data
Aug. 5, 2021 (EP) 21189999.2

(51) Int. Cl. H04W 48/20; H04W 88/04

(52) U.S. Cl. CPC H04W 48/20; H04W 88/04

(57) ABSTRACT

There is provided a method of operating a communications device. The communications device detects an indication of a relay service which can be provided by a communications node acting as a relay. The communications device determines, based at least in part on the detected indication of the relay service which can be provided by the relay communications node, whether to select the relay communications node.

### BACKGROUND

### Field

The present disclosure relates to communications devices, relay communications nodes, infrastructure equipment and methods of operating communications devices, relay communications nodes and infrastructure equipment. The present disclosure claims the Paris Convention priority of European patent application number EP21189999.2 filed on 5 Aug. 2021, the contents of which are incorporated herein by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will be expected to support communications routinely and efficiently with a wider range of devices associated with a wider range of data traffic profiles and types than current systems are optimised to support. For example, it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems [1], as well as future iterations/releases of existing systems, to efficiently support connectivity for a wide range of devices associated with different applications and different characteristic data traffic profiles.

In order to reduce power consumption, make efficient use of available spectrum, and/or for any other reason, communications devices may be configured to communicate using a sidelink connection with, or via, a relay communications device, or via a Uu network relay (for example, an Integrated Access and Backhaul (IAB) communications node). However, this gives rise to new challenges for efficiently handling communications in wireless telecommunications systems that need to be addressed.

### SUMMARY

The present disclosure can help address or mitigate at least some of the issues discussed above.

Example embodiments can provide a method of operating a communications device. The communications device detects an indication of a relay service which can be provided by a communications node acting as a relay. The communications device determines, based at least in part on the detected indication of the relay service which can be provided by the relay communications node, whether to select the relay communications node.

For example, the communications device may receive the indication of the relay service from the relay communications node itself or from infrastructure equipment. The relay communications node may be a relay communications device (such as a UE) or a network communications node such as an JAB communications node. The relay service provided by a relay communications node may alternatively be referred to as the “type” of the relay communications node. The indication of the relay service may include an indication of a mobility of the relay communications node. For example, the indication of the mobility of the relay communications node may indicate whether the relay communications node is mobile and/or a speed or direction of the relay communications node. Examples of mobile relay communications nodes are drones or land vehicles which can employ vehicle to everything (V2X) communications. The indication of the relay service may include an indication of a height of the relay communications node. The indication of the relay service may include an indication that a next-hop communications node for the relay communications node is an infrastructure equipment. For example, the relay communications node may be a U2N communications device as will be explained in more detail below. The indication of the relay service may include an indication that a next-hop communications node for the relay communications node is another communications device. For example, the relay communications node may be a U2U communications device as will be explained in more detail below. The indication of the relay service may include an indication that the relay communications node is configured to be used as a relay communications node for a finite time duration. In other words, the relay communications node may be a temporary communications node which is only available to be used for relaying communications for a finite time duration. In some cases, the indication may include the finite time duration. The indication of the relay service may include an indication that the relay communications node is reserved for emergency communications. In other words, the relay communications node may be deployed for a specified emergency purpose such as for relay communications to contact ambulance, police or fire services. In such cases, the communications may only use the relay communications node for relaying communications for the specified emergency purpose.

As mentioned above, the communications device determines, based at least in part on the detected indication of the relay service which can be provided by the relay communications node, whether to select the relay communications node. In one example, the communications device determines whether to select the relay communications node as an attachment to a wireless communications network, or as a target communications device for handover, or as an initial access to the wireless communications network. For example, as part of a handover procedure, the communications device may determine to handover or not to handover to the relay communications node based on the indication of the relay service. Similarly, if the communications device is already connected to the relay communications node, the communications device may determine to handover or not to handover from the communications device to another communications node. In other examples, the communications device may be in a RRC_INACTIVE or in a RRC_CONNECTED state and determines whether or not to transmit or receive data via the relay communications node based on the indication of the relay service. In other examples, the communications device may be in an RRC_IDLE state and determines whether or not to select the relay communications node as part of a cell selection procedure.

In some embodiments, the determining whether to select the relay communications node may be based on a combination of a communications service required by the communications device and the detected indication of the relay service which can be provided by the relay communications node. Examples of communications services which may be required by the communications device may include Ultra Low Latency (URLLC) services, Enhanced Mobile Broadband (eMBB) services, video conferencing services, computer games services or any other communications service as will be appreciated by one skilled in the art.

References to “communications node” herein are to be understood as referring to communications devices (such as UEs) or network infrastructure equipment (such as gNBs, eNBs, TRPs) in a wireless communications network.

Other example embodiments can provide a method of operating a communications node acting as a relay. The relay communications node provides, to a communications device, an indication of a relay service which can be provided by the relay communications node. The relay communications node receives an indication that the relay communications node has been selected by the communications device. In response, the relay communications node provides the relay service to the communications device.

Other example embodiments can provide a method of operating an infrastructure equipment. The infrastructure equipment provides, to a communications device, an indication of a relay service which can be provided by a communications node acting as a relay. The infrastructure equipment receives, from the communications device, an indication that the relay communications node has been selected by the communications device. In response, the infrastructure equipment transmits an indication to the selected relay communications node that the selected relay communications node has been selected by the communications device.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 schematically represents a relay device and a remote device communicating using a wireless communications network including a plurality of radio network infrastructure equipment according to example embodiments;

FIG. 4 schematically represents a group of communications devices communicating with infrastructure equipment via a relay communications device according to example embodiments;

FIG. 5 schematically represents a group of communications devices communicating with each other via a relay communications device according to example embodiments;

FIG. 6 is a schematic block diagram and part flow diagram illustrating communications between infrastructure equipment, a remote communications device and a relay communications device according to example embodiments;

FIG. 7 is a message flow diagram illustrating communications between infrastructure equipment, a remote communications device and a relay communications device according to example embodiments;

FIG. 8 schematically represents infrastructure equipment, a remote communications device and a relay communications device which may be configured to operate in accordance with example embodiments.

### DETAILED DESCRIPTION OF THE EMBODIMENTS

### Long Term Evolution (LTE) Wireless Communications System

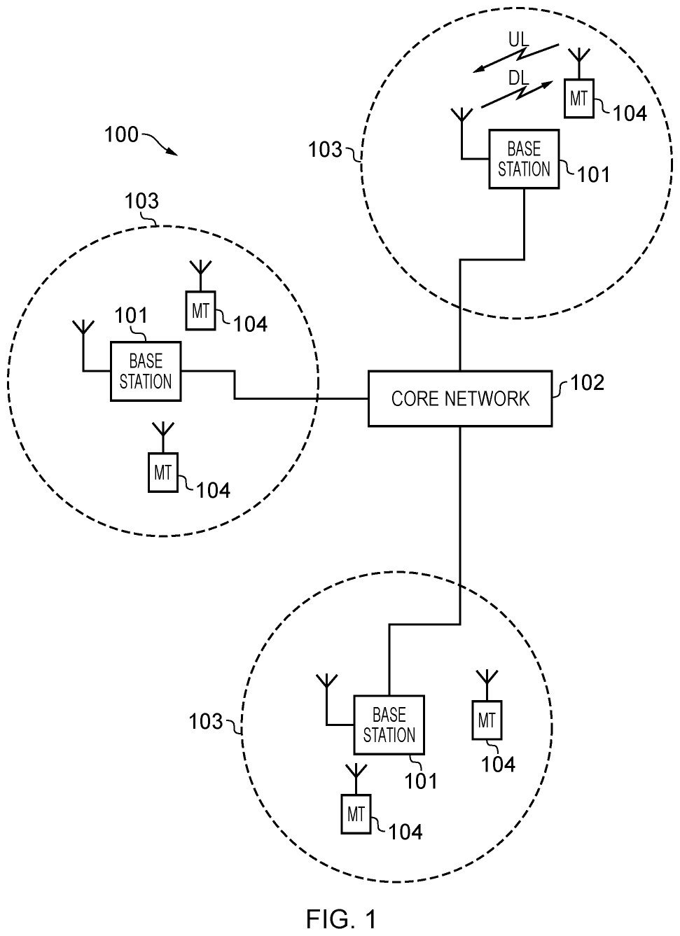

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Downlink data is transmitted from the base stations 101 to the communications devices 104 within their respective coverage areas 103 via a radio downlink. Uplink data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs, g-nodeBs (gNB) and so forth. In this regard different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G) Wireless Communications System

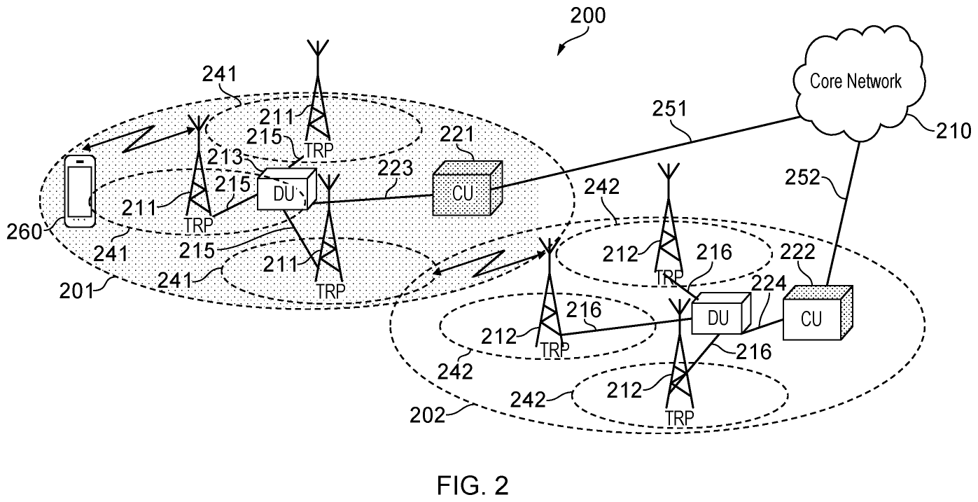

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (DUs) connected to (radio access nodes/remote transmission and reception points (TRPs)) 211, 212 in their respective cells. Again, these communications may be over respective wired or wireless links. The TRPs 211, 212 are responsible for providing the radio access interface for communications devices connected to the network. Each TRP 211, 212 has a coverage area (radio access footprint) 241, 242 where the sum of the coverage areas of the TRPs under the control of a controlling node together define the coverage of the respective communication cells 201, 202. Each TRP 211, 212 includes transceiver circuitry for transmission and reception of wireless signals and processor circuitry configured to control the respective TRP 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of TRPs 211 associated with the first communication cell 201. In some cases, communications for a given communications device are routed through only one of the TRPs, but it will be appreciated that in some other implementations communications associated with a given communications device may be routed through more than one TRP, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated that the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

### Sidelink UE Relay

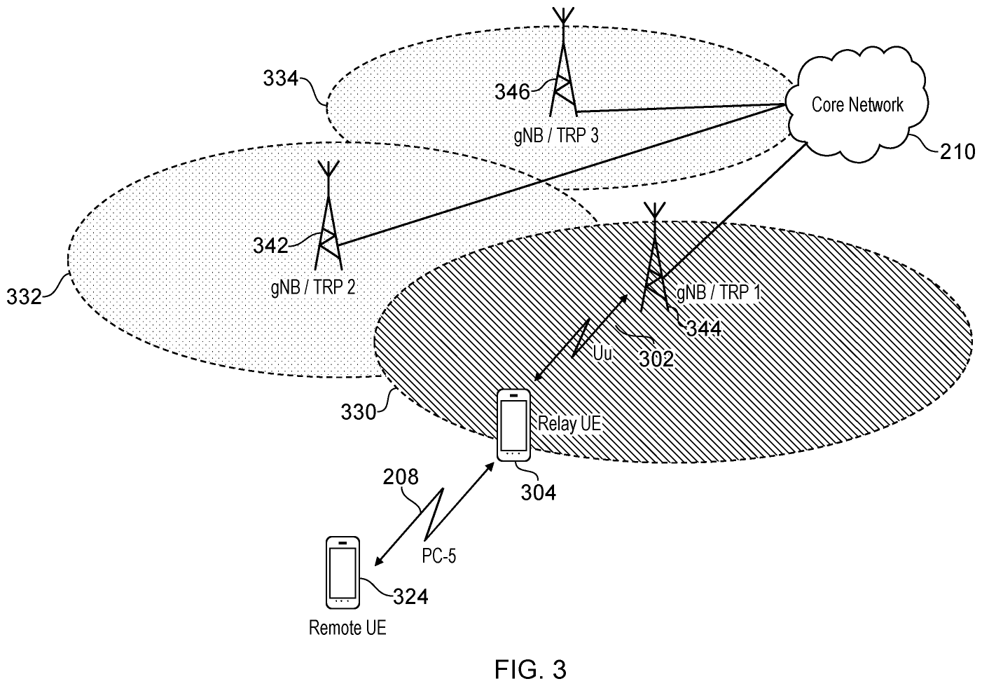

FIG. 3 illustrates an example embodiment, in which a UE 304 acts as a relay for a remote UE 324. The example shown in FIG. 3 provides an example of a wireless communications network, which may be formed according to either of the examples of FIGS. 1 and 2, in which three cells 330, 332, 334 are formed respectively by three gNB or TRPs 344, 342, 346 connected to a core network 210. The three gNBs or TRPs include gNB/TRP 1 344, gNB/TRP 2 342 and gNB TRP 3 346. The wireless communications network may be formed according to either of the examples shown in FIGS. 1 and 2.

It has been proposed that communications devices (UEs) may communicate directly between each other, either using licensed spectrum or unlicensed spectrum. This type of communication may generally be referred to as ‘device-to-device’ (D2D) communication, and may include the case where the D2D communication is provided in order to allow a ‘remote’ communications device 324 to transmit or receive data from a wireless communications network via a ‘relay’ communications device 304, whether or not the remote communications device 324 is within communications range of an infrastructure equipment of the network. For the example shown in FIG. 3, the relay UE 304 is within coverage of the gNB/TRP 1 344 and transmitting and receiving data via a wireless access interface Uu 302 within the cell 330. The remote UE 324 is outside the coverage provided by the gNB/TRP 1 344 within the cell 330 and transmits to and receives data from the relay UE 304 via a PC-5 side link wireless access interface 208 to the gNB/TRP 1 344 via the UE 304 which acts as a relay UE. The example embodiment shown in FIG. 3 relates to a UE-to-network, U2N, relay in which the Relay UE 304 relays signals and data between the remote UE 324 and the wireless communications network.

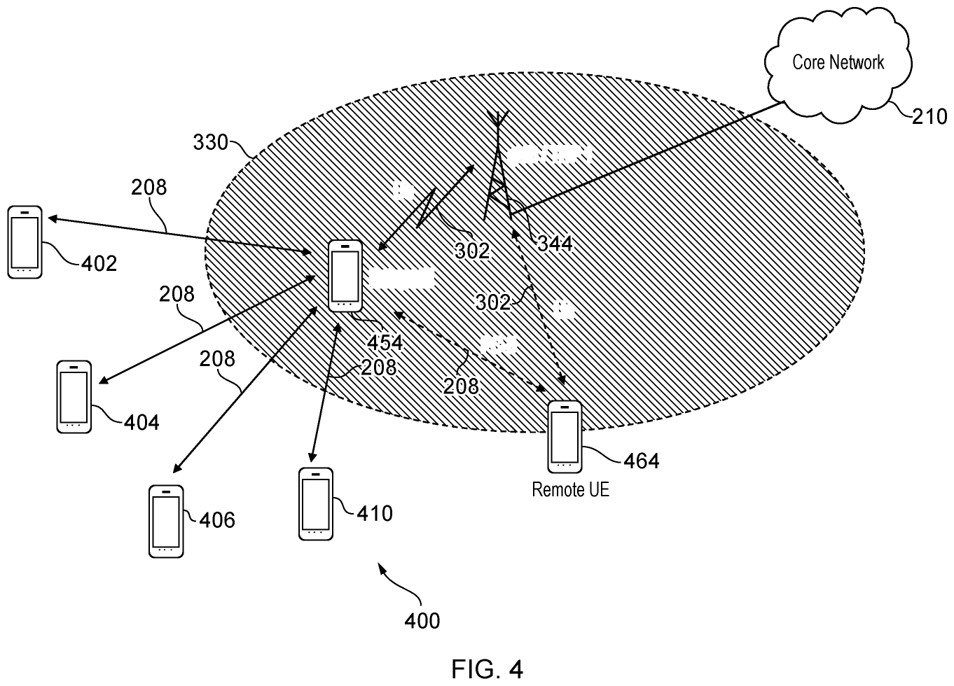

A further example embodiment is shown in FIG. 4, which illustrates an example in which a group of UEs 400 communicate via a relay UE 454. As shown in FIG. 4 the relay UE 454 is within coverage of the cell 330 of FIG. 3 and relays data and signals transmitted from each UE 402, 404, 406, 410 of the group 400 transmitted and received via PC-5 wireless access interfaces 208. As for the example of FIG. 3, the relay UE 454 transmits and receives data via a Uu wireless access interface 302 to and from the gNB/TRP 344 within the coverage area provided by the cell 330.

Also shown in FIG. 4 is another remote UE 464 at a boundary of the cell 330. The remote UE 464 at the cell boundary can transmit and receive data via a Uu wireless access interface formed by the gNB/TRP 344 or transmit or receive data to the network via a PC-5 wireless access interface 208 formed by the relay UE 454 as for the UEs in the group 400.

Example embodiments can provide a remote UE which can receive an indication from a relay UE, which indicates whether the relay UE is able to act as a relay UE and moreover a type of relay which the UE can provide, which allows the remote UE to determine whether it should select the relay UE or not.

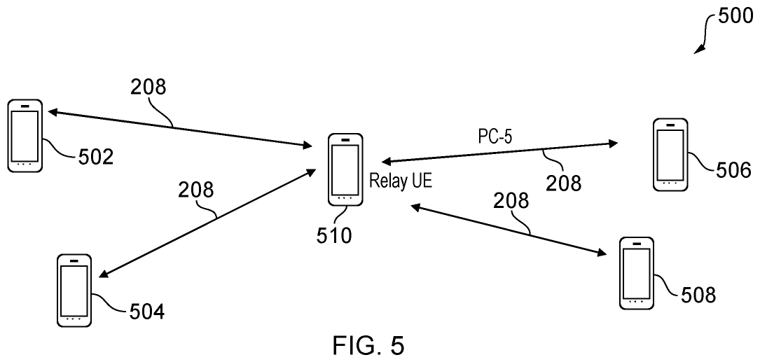

In other example embodiments, D2D communication may permit communications devices to communicate data directly between each other, without the data traversing any infrastructure equipment of the network. This latter scenario may permit, for example, communication between devices where there is no coverage of any infrastructure equipment. Such an example is shown in FIG. 5 which provides an example of a UE-to-UE, U2U, relay. As shown in FIG. 5, a group of five UEs are shown four of which 502, 504, 506, 508 are communicating with each other via a fifth of the UEs 510 via respective PC-5 interfaces 208. According to this examples embodiment, the fifth relay UE 510 acts as a relay, which provides an example of a U2U relay.

A study item being considered by 3GPP, for example in SID RP-193253 [3], is a side link-based relay, to support U2N and U2U relay, focusing on the following aspects, if applicable, for layer-3 relay and layer-2 relay [RAN2];
Relay (re-)selection criterion and procedure;
Relay/Remote UE authorization;
QoS for relaying functionality;
Service continuity;
Security of relayed connection after SA3 has provided its conclusions;
Impact on user plane protocol stack and control plane procedure, e.g., connection management of relayed connection;

There is also a proposal to support upper layer operations of discovery model/procedure for sidelink relaying, assuming no new physical layer channel/signal [RAN2]:
The study shall take into account of further input from SA WGs, e.g., SA2 and SA3, for the bullets above (if applicable).
It is assumed that U2N relay and U2U relay use the same relaying solution.
Forward compatibility for multi-hop relay support in a future release needs to be taken into account.
For layer-2 UE-to-network relay, the architecture of end-to-end PDCP and hop-by-hop RLC, e.g., as recommended in TR 36.746, is taken as starting point.

Accordingly, there is a requirement to support both U2N and U2U relay operation with different types of relays that will co-exist in the network e.g. U2N UE relay, U2U UE relay, mobile relay, JAB etc. The type of relay is information which can be used to improve relay selection/re-selection and mobility by UEs depending on their requirements.

### Adapted Operation for UE to Select U2U or U2N Operation

Accordingly, example embodiments can provide a method of operating a communications device. The communications device detects an indication of a relay service which can be provided by a communications node acting as a relay. The communications device determines, based at least in part on the detected indication of the relay service which can be provided by the relay communications node, whether to select the relay communications node.

The indication of the relay service may be a relay type indicator, which is included in the signalling to UEs in order to allow a UE to perform an appropriate relay selection/re-selection or mobility procedure.

According to example embodiments as shown in FIGS. 3 to 5 a selection of a relay by a UE may provide an advantage for both U2U or U2N:
1. Certain grouped UEs, such as the groups 400, 500 shown in FIGS. 4 and 5, may be for example video game players, family members etc. As such, the group 400, 500, may prefer a U2U relay to forward its traffic to other members of the group, perhaps in close proximity, rather than using a U2N relay to forward the traffic via the relay to a wireless communications network then to other members in order to for example reduce delay, or can select someone you know to relay the traffic (one of the video game players is selected as a relay).
2. Certain grouped UEs for example a passenger in a car, may prefer to select this car as a U2N relay in order to initiate a video call with a friend who stays at home, rather than to select the other passenger as a U2U relay in the same car.

In the above scenarios, the information of whether a relay is a U2U or U2N relay can be used by a remote UE in order to select an appropriate UE relay.

According to other example embodiments, a UE or more generally a communications node may be mobile and configured to act as a relay node for other UEs. In some examples the mobile UE may be a flying aircraft or device such as a drone. For example, an aircraft or a bus may provide a local communications network so that the passengers in the aircraft or bus, which is mobile would be better served by selecting the local communications network with the aircraft or bus acting as a mobile relay node, otherwise UEs used by the passengers would be disrupted by frequent handovers or re-selections. In contrast, a UE used by a pedestrian who is stopping at a bus stop may not prefer to select the bus as a relay. According to another example, a UE which is about to execute a handover would be better served by not selecting a highly mobile a drone as its relay node if there are more than one base station (TRP/gNB) which can fulfil conditions for a conditional handover (CHO) such as in the CHO configuration and the UE is in power saving (green) mode. This is because a transmission power required to communicate with a drone as a relay node could be higher in order to connect to the drone relay. According to example embodiments therefore, a UE may select another device/node/IAB infrastructure equipment depending on (a) a type of relay services being offered and be a requirement of the UE in respect of conditions for a communications service required by the UE.

According to another example, a communications device may require a communications service such as a video conferencing service. In one example, a user of a communications device at a bus stop may desire to initiate video conference call with another user of a different communications device at a remote location. In this example, the bus may be configured to act as a relay communications device by relaying signals from the communications device of the user at the bus stop to a radio access network for transmission to the communications device at the remote location. However, in this example, since the bus is likely to move off soon, it may be undesirable for the communications device at the bus stop to use the bus as a relay communications device. Despite this, conventional protocols may dictate that the communications device uses the bus as a relay because of improved signal strength for example. In accordance with example embodiments, the communications device at a bus stop may determine not to select the bus as a relay communications device based on an indication that the bus is a mobile relay communications device.

According to another example, a UE may determine whether or not to select a particular relay communications node based at least in part on a height of the relay communications node. For example, the indication of the relay service which can be provided by the relay communications node may include an indication of the height of the relay communications node. Alternatively, the relay communications may indicate its height to the UE which determines whether or not to select the relay communications node in a separate signal. Embodiments in which it is particularly advantageous to base the decision of whether to select a relay communications node on the height of the relay communications node include, for example, embodiments in which the relay communications node is an underground relay communications node, an underwater relay communications node, an airborne relay communications node, or an on-ground relay communications node implemented in a vehicle such as a train, bus, or car. In some embodiments, the indication of the height of the relay communications node may specifically include an indication of an operating height of the relay communications.

According to another example a UE, which is passing by communications device which can act as a relay. However, the UE will not select this communications device as a relay except for an emergency purpose if the user of the UE is in a dangerous situation or if the UE is being used for public safety or by emergency services.

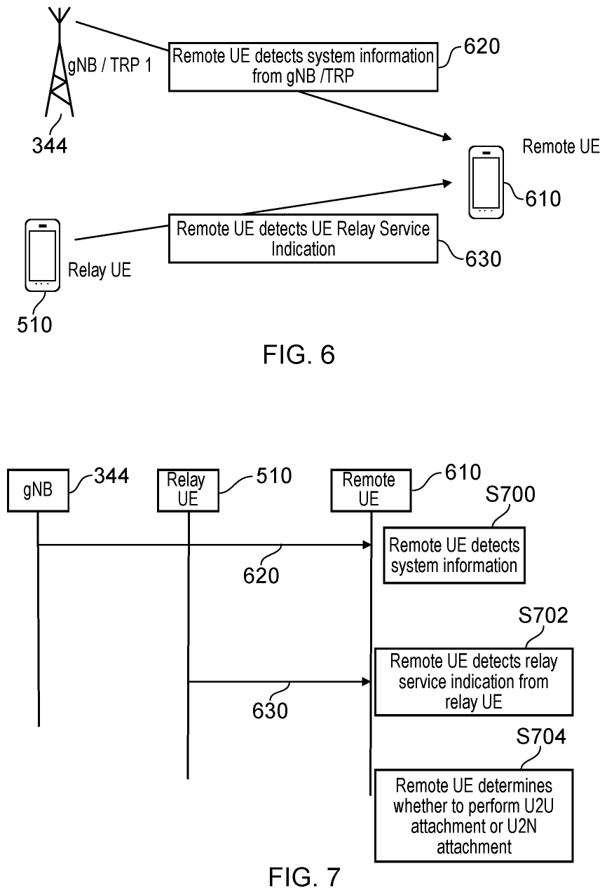

Example embodiments which can apply to any of the examples of FIG. 3, 4 or 5 are represent by a part message flow diagram, part flow diagrams of FIGS. 6 and 7. As shown in FIGS. 6 and 7 a remote UE 610 detects information transmitting by communications nodes/devices/UEs or infrastructure equipment (TRP, eNB etc), which indicate a relay service which the communications node can provide. As shown in FIGS. 6 and 7 the remote UE 610 detects the system information 620, which may be conventional information at step S700. The remote UE 610 also detects a relay service indication 630 from a relay UE 510 as represented by a step S702 in FIG. 7. The remote UE 610 then determines whether to perform a U2U or U2N attachment or handover via the relay UE 510 or perform an attachment or handover to the gNB/TRP 344.

### Example Signalling to Provide Relay Indication

As indicated by the examples embodiments of FIGS. 3 to 7, communications devices/nodes which can act as a relay to UEs transmit relay type information, from which remote UEs can determine a relay service which can be supported. Examples of the relay type information can be any one or combination of the following information: a U2U relay indication, a U2N relay indication, a mobile relay and/or its speed (level of speed) indication, a drone relay indication, a temporary relay indication, an emergency relay indication.

There are various examples in which embodiments can communicate the relay service indication:
Option 1: To include the relay type indicator in the broadcast signalling of the relay node. When UE received this information from broadcast signalling, it can decide whether it will access to this type of relay or not. As another embodiment, a mobile relay will broadcast its moving speed/direction and UE can make use of it to calculate the relative speed with this relay, in order to decide whether it can access to this relay or not.
Option 2: UE relay can include relay type indicator in its discovery message. For UE relay, relay type information can be included in the discover message.
Option 3: Relay type indication can be included in the HO configuration or CHO configuration. If UE needs to handover from BS to relay, or from a relay to another relay, the relay type indication can be included in the HO configuration message. The UE can even send a reject message with reject cause to network if it doesn't want to handover to the destination relay node. For CHO configuration, if the candidate destination node is a relay node, an infrastructure equipment (base station) will add relay type information in the CHO configuration and it will be up to the remote UE to decide whether it wants to handover to this type of relay.
Option 4: On-demand relay type indicator on request by a remote UE. A remote UE may request the relay type indicator from the relay or the infrastructure node e.g. its serving node, then the relay or the infrastructure node sends the relay type. Alternatively, a UE may request the assistance information of relay type including that of neighbour relays.

A UE may be configured by the network to use a certain type of relay type for a particular service. This information may be provided by NAS or AS signalling to the UE. For example, a game service will prefer U2U relay and voice application will prefer U2N. In some embodiments, a particular communications service may only be available on particular communications frequencies. In such embodiments, the UE may determine that the particular service is not available on a frequency that the UE is currently using for communications. In this case, the UE may select another frequency at which the particular service is available. In one example, the UE may determine that a peer-to-peer communications service using a U2U relay is available on a communications frequency other than the one which the UE is currently using, and accordingly selects to use the other frequency for the peer-to-peer service. The UE may receive information regarding whether or not particular communications services are available or not on particular frequencies from the relay communications node itself, or from infrastructure equipment which provides coverage for the UE.

Relay type information may be provided from a neighbour cell or serving cell i.e. UE is aware of Relay types in the vicinity and make a decision for cell reselection. So, a cell may broadcast a relay ID, in terms of PCI or if a new Relay ID is defined, along with a relay type information.

In some examples the communications device/node, UE or infrastructure equipment may form a communications node in an Integrated and Access and Backhaul network.

An example scenario in which embodiments of the present technique may be deployed is a personal internet of things “PIoT” network. A PIoT network may comprise one or more PIoT devices communicating between themselves and a ‘master user equipment (UE)’. The master UE may be a smartphone, residential gateway, or the like, and may provide connectivity to a cellular network, such as a 3GPP 5G radio access network. Connections within the PIoT network may be by means of device-to-device communication, and the master UE may act as a relay. Where the master UE or ‘gateway UE’ connects to a 5G network, the master UE may be referred to in some scenarios as a 5G residential gateway (5G-RG).

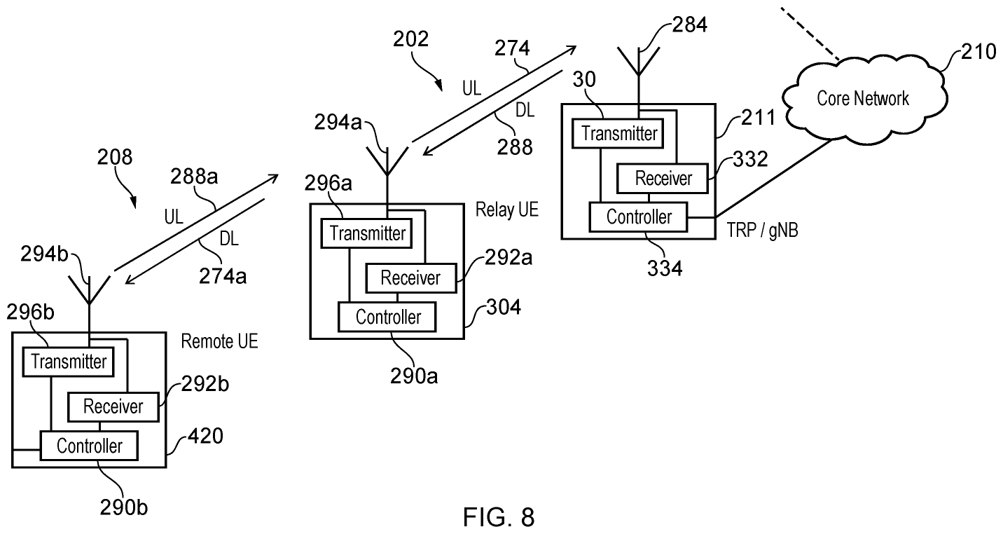

FIG. 8 illustrates in more detail communications devices and infrastructure equipment which may be adapted in accordance with embodiments of the present technique, and in particular illustrates the use of a side link for device-to-device communications.

In FIG. 8, a TRP 211 broadly corresponding to TRPs 211, 212, 342, 344, 346 as shown in FIGS. 2 to 4 comprises, as a simplified representation, a wireless transmitter 30, a wireless receiver 332 and a controller or controlling processor 334 which may operate to control the transmitter 30 and the wireless receiver 332 to transmit and receive radio signals to one or more communications devices via a wireless access interface via an antenna 284.

In FIG. 8, an example communications device 304 is shown, which communicates with the TRP 211 via a wireless access interface 202 by transmitting signals on an uplink 274 and receiving signals on a downlink 288. The example communications device or UE 304 acts as a relay UE to a second communications device 420, which will be referred to as a remote UE. The wireless access interface 202 via which signals may be transmitted on the uplink 274 and signals may be transmitted on the downlink 288 may be in accordance with a Uu interface of a 3GPP specification.

For communicating via the wireless access interface, the relay UE 304 comprises a wireless transmitter 296a and a wireless receiver 292a, which are connected to an antenna 294a and are controlled by a controller or controlling processor 290a.

The wireless transmitter 296a, wireless receiver 292a and antenna 294a allow the relay UE 304 to communicate via the wireless access interface 202 provided by the TRP 211.

As shown in FIG. 8 the remote UE 420 also includes a wireless transmitter 296b and a wireless receiver 292b, which are connected to an antenna 294b and are controlled by a controller or controlling processor 290b. As will be appreciated the transmitter 296b, the receiver 292b and the controller 290b may operate in the same way as the corresponding transmitter 296a, receiver 292a and controller 290a of the relay UE 304. However the transmitter 296b, the receiver 292b and the controller 290b of the remote UE 420 are configured with the transmitter 296a, receiver 292a and controller 290a of the relay UE 304 to transmit uplink signals 288a and downlink signals 274a via a sidelink wireless access interface 208 formed between the remote UE 420 and the relay UE 304. The sidelink 208 may use communication resources in licensed or unlicensed spectrum, or a combination of both, as will be further described below.

As will be explained below, in some scenarios, the remote UE 420 may be within range of the TRP 211, and accordingly may additionally communicate directly with the TRP 211 using the wireless access interface provided by the TRP 211.

The transmitters 296a, 296b, 30 and the receivers 332, 292a, 292b (as well as other transmitters, receivers and transceivers described in relation to examples and embodiments of the present disclosure) may include radio frequency filters and amplifiers as well as signal processing components and devices in order to transmit and receive radio signals in accordance with a particular standard. For example, the transmitters 296a, 30 and the receivers 332, 292a, for allowing communication via the uplink 274 and downlink 288 of the wireless access interface provided by the TRP 211 may be configured in accordance with the 5G/NR standard. The second transmitters 296b and the second receivers 292b, for allowing communication via the sidelink using unlicensed spectrum may be configured in accordance with a Bluetooth® or IEEE 802.11/WiFi® standard.

The controllers 334, 290a, 290b (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, which may be non-volatile memory, operating according to instructions stored on a computer readable medium.

Not shown in FIG. 8, the TRP 211 also includes a network interface, which connects to a DU (such as the DU 213 shown in FIG. 2) via a physical interface. The network interface therefore provides a communication link for data and signalling traffic from the TRP 211 via the DU 213 and the CU 221 to the core network 210.

The interface between the DU 213 and the CU 221 may be known as the F1 interface (such as F1 interface 223 visible in FIG. 2) which can be a physical or a logical interface. The F1 interface 223 between CU and DU may operate in accordance with specifications 3GPP TS 38.470 and 3GPP TS 38.473, and may be formed from a fibre optic or other wired high bandwidth connection. In one example the connection (such as connection 215 visible in FIG. 2) from the TRP 211 to the DU 213 is via fibre optic. The connection between a TRP 211 and the core network 210 can be generally referred to as a backhaul, which comprises the connection 215 between the TRP 211 and the DU 213 and the F1 interface 223 from the DU 213 to the CU 221.

In some embodiments, the connection between the relay UE 304 and the core network may be via a wireless backhaul interface provided by an infrastructure equipment. In an example of such an arrangement, the relay UE 304 may function as an JAB node. As in FIG. 8, the relay UE 304, acting as a relay, may be a gateway, a 5G-RG and/or a master UE.

Corresponding apparatus and circuitry have also been described.

According to the above explanation, example embodiments can provide a method of operating a communications device to receive signals from a wireless communications network. The communications device identifies a plurality of communications nodes in the wireless communications network with which the communications device can attach to form a wireless communications link for transmitting data via an attached one of the plurality of communications nodes to the destination communications device, or for receiving data via the attached communications node from the destination communications device, at least one of the plurality of communications nodes being a communications device acting as a relay communications device, the at least one relay communications device being configured to transmit data received from the communications device to the destination communications device via a next-hop communications node in the wireless communications network for the at least one relay communications device, or to transmit data received from the destination communication device via the next-hop communications node to the communications device, the next-hop communications node being the destination communications device or another communications node in the wireless communications network. The communications device receives an indication of a type of the at least one relay communications device including one or more of an indication of a mobility of the at least one relay communications device, an indication that the next-hop communications node for the at least one relay communications device is an infrastructure equipment or another communications device, an indication that the at least one relay communications device is configured to be used as a relay communications device for a finite time duration, or an indication that the at least one relay communications device is reserved for emergency communications. The communications device selects based at least in part on the received indication of the type of the at least one relay communications device, one of the plurality of communications nodes with which to attach, or which is attached to the communications device, to form a wireless communications link for transmitting data via the selected communications node to the destination communications device, or for receiving data via the selected communications node from the destination communications device.

It will be appreciated that while the present disclosure has in some respects focused on implementations in an LTE-based and/or 5G network for the sake of providing specific examples, the same principles can be applied to other wireless telecommunications systems. Thus, even though the terminology used herein is generally the same or similar to that of the LTE and 5G standards, the teachings are not limited to the present versions of LTE and 5G and could apply equally to any appropriate arrangement not based on LTE or 5G and/or compliant with any other future version of an LTE, 5G or other standard.

It may be noted various example approaches discussed herein may rely on information which is predetermined/predefined in the sense of being known by both the base station and the communications device. It will be appreciated such predetermined/predefined information may in general be established, for example, by definition in an operating standard for the wireless telecommunication system, or in previously exchanged signalling between the base station and communications devices, for example in system information signalling, or in association with radio resource control setup signalling, or in information stored in a SIM application. That is to say, the specific manner in which the relevant predefined information is established and shared between the various elements of the wireless telecommunications system is not of primary significance to the principles of operation described herein. It may further be noted various example approaches discussed herein rely on information which is exchanged/communicated between various elements of the wireless telecommunications system and it will be appreciated such communications may in general be made in accordance with conventional techniques, for example in terms of specific signalling protocols and the type of communication channel used, unless the context demands otherwise. That is to say, the specific manner in which the relevant information is exchanged between the various elements of the wireless telecommunications system is not of primary significance to the principles of operation described herein.

It will be appreciated that the principles described herein are not applicable only to certain types of communications device, but can be applied more generally in respect of any types of communications device, for example the approaches are not limited to machine type communications devices/IoT devices, but can be applied more generally, for example in respect of any type of sidelink providing a wireless link to a communications device.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered paragraphs:

Paragraph 1. A method of operating a communications device, the method comprising
detecting, by the communications device, an indication of a relay service which can be provided by a communications node acting as a relay, and
determining, by the communications device, based at least in part on the detected indication of the relay service which can be provided by the relay communications node, whether to select the relay communications node.

Paragraph 2. A method according to paragraph 1, wherein the indication of the relay service which can be provided by the relay communications node includes one or more of an indication of a mobility of the relay communications node, an indication that a next-hop communications node for the relay communications node is an infrastructure equipment, U2N, or another communications device, U2U, an indication that the relay communications node is configured to be used as a relay communications node for a finite time duration, an indication that the relay communications node is reserved for emergency communications, or an indication of a height of the relay communications node.

Paragraph 3. A method according to paragraph 1 or 2, wherein the determining, by the communications device, based at least in part on the detected indication of the relay service which can be provided by the relay communications node, whether to select the relay communications node, includes
determining whether to select the relay communications node based on a combination of a communications service required by the communications device and the detected indication of the relay service which can be provided by the relay communications node.

Paragraph 4. A method according to paragraph 1, 2 or 3, wherein the determining, by the communications device, whether to select the relay communications node, includes
determining whether to select the relay communications node as an attachment to a wireless communications network, or as a target communications device for handover, or as an initial access to the wireless communications network.

Paragraph 5. A method according to any preceding paragraph, wherein the detecting, by the communications device, the indication of a relay service which can be provided by the relay communications node comprises
identifying, by the communications device, a plurality of communications nodes in the wireless communications network with which the communications device can attach to form a wireless communications link for transmitting data or for receiving data via the attached communications node, at least one of the plurality of communications nodes being the relay communications node, the at least one relay communications node being configured to transmit data to, or receive data from, another communications node via a next-hop communications node.

Paragraph 6. A method according to paragraph 5, wherein the determining, by the communications device, based at least in part on the detected indication of the relay service which can be provided by the relay communications node, whether to select the relay communications node, includes
selecting, by the communications device based at least in part on the detected indication of the type of the relay service which can be provided by the relay communications node, one of the plurality of communications nodes with which to attach, or which is attached to the communications device, to form a wireless communications link for transmitting or receiving data via the selected communications node.

Paragraph 7. A method according to any preceding paragraph wherein the detecting, by the communications device, the indication of the relay service which can be provided by the relay communications node comprises receiving the indication of the relay service from the relay communications node.

Paragraph 8. A method according to paragraph 7, wherein the receiving the indication of the relay service from the relay communications node comprises
receiving the indication of the relay service in a broadcast signal from the relay communications node.

Paragraph 9. A method according to paragraph 7, wherein the receiving the indication of the relay service from the relay communications node comprises
receiving a discovery message from the relay communications node including the indication of the relay service which can be provided by the relay communications node.

Paragraph 10. A method according to any preceding paragraph, wherein the detecting, by the communications device, the indication of the relay service which can be provided by the relay communications node comprises
transmitting, by the communications device, a discovery signal to the relay communications node, and in response,
receiving, from the relay communications node, a discovery response signal including the indication of the relay service.

Paragraph 11. A method according to any preceding paragraph, comprising
receiving a handover configuration signal for a handover of the communications device, the relay communications node being a source or a target of the handover, wherein the indication of the relay service which can be provided by the relay communications node is included in the handover configuration signal, and the determining, by the communications device, based at least in part on the detected indication of the relay service which can be provided by the relay communications node, whether to select the relay communications node comprises
determining whether or not to handover from the relay communications node to another communications node if the relay communications node is the source of the handover, or whether or not to handover from the other communications node to the relay communications node if the relay communications node is the target for the handover, and, if the communications device determines not to handover, transmitting a handover reject signal.

Paragraph 12. A method according to any preceding paragraph, comprising
receiving a conditional handover configuration message including an indication of one or more conditions which must be met to trigger a handover of the communications device, the relay communications node being a source or a target of the handover, wherein the indication of relay service which can be provided by the relay communications node is included in the conditional handover signal, and the determining, by the communications device, based at least in part on the detected indication of the relay service which can be provided by the relay communications node, whether to select the relay communications node comprises
determining whether or not to handover from the relay communications node to another communications node if the relay communications node is the source of the handover, or whether or not to handover from the other communications device to the relay communications node if the relay communications node is the target for the handover.

Paragraph 13. A method according to any preceding paragraph, wherein the detecting, by the communications device, the indication of the relay service which can be provided by the relay communications node comprises
transmitting, by the communications device, a relay type request to the relay communications node, and in response,
receiving the indication of the relay service from the relay communications node.

Paragraph 14. A method according to any preceding paragraph, wherein the detecting, by the communications device, the indication of the relay service which can be provided by the relay communications node comprises
transmitting, by the communications device, a relay type request to an infrastructure equipment which provides a communications cell for the communications device, and in response,
receiving, from the infrastructure equipment which provides the communications cell for the communications device, the indication of the relay service which can be provided by the relay communications node.

Paragraph 15. A method according to any preceding paragraph, wherein the detecting, by the communications device, the indication of the relay service which can be provided by the relay communications node comprises
receiving the indication of the relay service which can be provided by the relay communications node from an infrastructure equipment of a wireless communications network.

Paragraph 16. A method according to paragraph 15, wherein the detecting, by the communications device, the indication of the relay service which can be provided by the relay communications node comprises
receiving an identification of the relay communications node from the infrastructure equipment of the wireless communications network, and
the receiving the indication of the relay service which can be provided by the relay communications node from the infrastructure equipment of the wireless communications network includes receiving the indication of the relay service which can be provided by the relay communications node along with the identification of the relay communications node.

Paragraph 17. A method according to paragraph 16, the indication of the relay service which can be provided by the relay communications node received along with the identification of the relay communications node is received from the infrastructure equipment as a broadcast signal.

Paragraph 18. A method according to any preceding paragraph, comprising
receiving, from a core network, a preferred mapping between one or more communications services and a respective one or more relay services for transmitting data according to the one or more communications services,
identifying a communications service to be used for communicating data to or from the communications device,
determining, based on the preferred mapping received from the core network and the identified communications service to be used for communicating data to or from the communications device, a preferred relay service for communicating the data according to the identified communications service, wherein the determining, by the communications device, based at least in part on the detected indication of the relay service which can be provided by the relay communications node, whether to select the relay communications node comprises
determining whether to select the relay communications node in accordance with whether the relay service which can be provided by the relay communications node is the preferred relay service determined by the communications device.

Paragraph 19. A method according to paragraph 18, comprising
determining, by the communications device, that the identified communications service for the preferred relay service is not available at a first communications channel currently being used by the communications device;
determining, by the communications device, that the identified communications service for the preferred relay service is available on a second communications channel which the communications device is configured to use; and
switching, by the communications device, from using the first communications channel currently being used to the second communications channel at which the identified communications service for the preferred relay service is available.

Paragraph 20. A method according to paragraph 18 or 19, wherein the preferred mapping received from the core network is received in one or more Non-Access Stratum, NAS, or Access Stratum, AS, signals from the core network.

Paragraph 21. A method according to any preceding paragraph, wherein the detecting, by the communications device, the indication of the relay service which can be provided by the relay communications node comprises
receiving an indication of the mobility of the relay communications node.

Paragraph 22. A method according to paragraph 21, wherein the indication of the mobility of the relay communications node includes an indication of a speed and a direction of the relay communications node and, in response to receiving the indication of the mobility of the relay communications node,
determining, by the communications device, a speed and a direction of the relay communications node relative to the communications device based on the received indication of the mobility of the relay communications node.

Paragraph 23. A method according to paragraph 21 or 22, wherein the indication of the mobility of the relay communications node includes an indication that the relay communications node is implemented in an aerial vehicle.

Paragraph 24. A method according to any preceding paragraph, wherein the detecting, by the communications device, the indication of the relay service which can be provided by the relay communications node comprises
receiving an indication that a next-hop communications node for the relay communications node is an infrastructure equipment.

Paragraph 25. A method according to paragraph 24, the receiving the indication that the next-hop communications node for the relay communications node is an infrastructure equipment comprises
receiving an indication that the relay communications node is a UE to network, U2N, relay communications node.

Paragraph 26. A method according to any preceding paragraph, wherein the detecting, by the communications device, the indication of the relay service which can be provided by the relay communications node comprises
receiving an indication that a next-hop communications node for the relay communications node is another communications device.

Paragraph 27. A method according to paragraph 26, the receiving the indication that the next-hop communications node for the relay communications node is another communications device comprises
receiving an indication that the at relay communications node is a UE to UE, U2U, relay communications node.

Paragraph 28. A method according to any preceding paragraph, wherein the detecting, by the communications device, the indication of the relay service which can be provided by the relay communications node comprises
receiving an indication that the relay communications node is reserved for emergency communications.

Paragraph 29. A method of operating a communications node acting as a relay, the method comprising providing, to a communications device, an indication of a relay service which can be provided by the relay communications node,
receiving, by the relay communications node, an indication that the relay communications node has been selected by the communications device, and in response,
providing the relay service to the communications device.

Paragraph 30. A method according to paragraph 29, wherein the indication of the relay service which can be provided by the relay communications node includes one or more of an indication of a mobility of the relay communications node, an indication that a next-hop communications node for the relay communications node is an infrastructure equipment, U2N, or another communications device, U2U, an indication that the relay communications node is configured to be used as a relay communications node for a finite time duration, an indication that the relay communications node is reserved for emergency communications, or an indication of a height of the relay communications node.

Paragraph 31. A method of operating an infrastructure equipment, the method comprising
providing, to a communications device, an indication of a relay service which can be provided by a communications node acting as a relay,
receiving, from the communications device, an indication that the relay communications node has been selected by the communications device, and in response,
transmitting an indication to the selected relay communications node that the selected relay communications node has been selected by the communications device.

Paragraph 32. A method according to paragraph 31, wherein the indication of the relay service which can be provided by the relay communications node includes one or more of an indication of a mobility of the relay communications node, an indication that a next-hop communications node for the relay communications node is an infrastructure equipment, U2N, or another communications device, U2U, an indication that the relay communications node is configured to be used as a relay communications node for a finite time duration, an indication that the relay communications node is reserved for emergency communications, or an indication of a height of the relay communications node.

Paragraph 33. A communications device comprising
transceiver circuitry configured to transmit and/or to receive signals,
control circuitry configured in combination with the transceiver circuitry to
detect an indication of a relay service which can be provided by a communications node acting as a relay, and
determine, based at least in part on the detected indication of the relay service which can be provided by the relay communications node, whether to select the relay communications node.

Paragraph 34. A communications node acting as a relay, the communications node comprising
transceiver circuitry configured to transmit and/or to receive signals,
control circuitry configured in combination with the transceiver circuitry to
provide, to a communications device, an indication of a relay service which can be provided by the relay communications node,
receive an indication that the relay communications node has been selected by the communications device, and in response,
provide the relay service to the communications device.

Paragraph 35. An infrastructure equipment comprising
transceiver circuitry configured to transmit and/or to receive signals,
control circuitry configured in combination with the transceiver circuitry to
provide, to a communications device, an indication of a relay service which can be provided by a communications node acting as a relay,
receive, from the communications device, an indication that the relay communications node has been selected by the communications device, and in response,
transmit an indication to the selected relay communications node that the selected relay communications node has been selected by the communications device.

Paragraph 36. Circuitry for a communications device, the circuitry comprising
transceiver circuitry configured to transmit and/or to receive signals,
control circuitry configured in combination with the transceiver circuitry to
detect an indication of a relay service which can be provided by a communications node acting as a relay, and
determine, based at least in part on the detected indication of the relay service which can be provided by the relay communications node, whether to select the relay communications node.

Paragraph 37. Circuitry for a communications node acting as a relay, the circuitry comprising transceiver circuitry configured to transmit and/or to receive signals,
control circuitry configured in combination with the transceiver circuitry to
provide, to a communications device, an indication of a relay service which can be provided by the relay communications node,
receive an indication that the relay communications node has been selected by the communications device, and in response,
provide the relay service to the communications device.

Paragraph 38. Circuitry for an infrastructure equipment, the circuitry comprising
transceiver circuitry configured to transmit and/or to receive signals,
control circuitry configured in combination with the transceiver circuitry to
provide, to a communications device, an indication of a relay service which can be provided by a communications node acting as a relay,
receive, from the communications device, an indication that the relay communications node has been selected by the communications device, and in response,
transmit an indication to the selected relay communications node that the selected relay communications node has been selected by the communications device.

Paragraph 39. A wireless communications network comprising a communications device according to paragraph 33 and a relay communications node according to paragraph 34.

Paragraph 40. A computer program comprising instructions which, when the program is executed by a computer, cause the computer to carry out the method of paragraph 1 or paragraph 29 or paragraph 31.

### REFERENCES

[1] 3GPP TS 38.300 v. 15.2.0 “NR; NR and NG-RAN Overall Description; Stage 2(Release 15)”, June 2018
[2] Holma H. and Toskala A, “LTE for UMTS OFDMA and SC-FDMA based radio access”, John Wiley and Sons, 2009
[3] Study Item Description (SID) RP-193253. Study on NR sidelink relay.

1. A method of operating a communications device, the method comprising
detecting, by the communications device, an indication of a relay service which can be provided by a communications node acting as a relay, and
determining, by the communications device, based at least in part on the detected indication of the relay service which can be provided by the relay communications node, whether to select the relay communications node.

2. A method according to claim 1, wherein the indication of the relay service which can be provided by the relay communications node includes one or more of an indication of a mobility of the relay communications node, an indication that a next-hop communications node for the relay communications node is an infrastructure equipment, U2N, or another communications device, U2U, an indication that the relay communications node is configured to be used as a relay communications node for a finite time duration, an indication that the relay communications node is reserved for emergency communications, or an indication of a height of the relay communications node.

3. A method according to claim 1, wherein the determining, by the communications device, based at least in part on the detected indication of the relay service which can be provided by the relay communications node, whether to select the relay communications node, includes
determining whether to select the relay communications node based on a combination of a communications service required by the communications device and the detected indication of the relay service which can be provided by the relay communications node.

4. A method according to claim 1, wherein the determining, by the communications device, whether to select the relay communications node, includes
determining whether to select the relay communications node as an attachment to a wireless communications network, or as a target communications device for handover, or as an initial access to the wireless communications network.

5. A method according to claim 1, wherein the detecting, by the communications device, the indication of a relay service which can be provided by the relay communications node comprises
identifying, by the communications device, a plurality of communications nodes in the wireless communications network with which the communications device can attach to form a wireless communications link for transmitting data or for receiving data via the attached communications node, at least one of the plurality of communications nodes being the relay communications node, the at least one relay communications node being configured to transmit data to, or receive data from, another communications node via a next-hop communications node.

6. A method according to claim 5, wherein the determining, by the communications device, based at least in part on the detected indication of the relay service which can be provided by the relay communications node, whether to select the relay communications node, includes
selecting, by the communications device based at least in part on the detected indication of the type of the relay service which can be provided by the relay communications node, one of the plurality of communications nodes with which to attach, or which is attached to the communications device, to form a wireless communications link for transmitting or receiving data via the selected communications node.

7. A method according to claim 1 wherein the detecting, by the communications device, the indication of the relay service which can be provided by the relay communications node comprises
receiving the indication of the relay service from the relay communications node.

8. A method according to claim 7, wherein the receiving the indication of the relay service from the relay communications node comprises
receiving the indication of the relay service in a broadcast signal from the relay communications node.

9. A method according to claim 7, wherein the receiving the indication of the relay service from the relay communications node comprises
receiving a discovery message from the relay communications node including the indication of the relay service which can be provided by the relay communications node.

10. A method according to claim 1, wherein the detecting, by the communications device, the indication of the relay service which can be provided by the relay communications node comprises
transmitting, by the communications device, a discovery signal to the relay communications node, and in response,
receiving, from the relay communications node, a discovery response signal including the indication of the relay service.

11. A method according to claim 1, comprising
receiving a handover configuration signal for a handover of the communications device, the relay communications node being a source or a target of the handover, wherein the indication of the relay service which can be provided by the relay communications node is included in the handover configuration signal, and the determining, by the communications device, based at least in part on the detected indication of the relay service which can be provided by the relay communications node, whether to select the relay communications node comprises
determining whether or not to handover from the relay communications node to another communications node if the relay communications node is the source of the handover, or whether or not to handover from the other communications node to the relay communications node if the relay communications node is the target for the handover, and, if the communications device determines not to handover, transmitting a handover reject signal.

12. A method according to claim 1, comprising
receiving a conditional handover configuration message including an indication of one or more conditions which must be met to trigger a handover of the communications device, the relay communications node being a source or a target of the handover, wherein the indication of relay service which can be provided by the relay communications node is included in the conditional handover signal, and the determining, by the communications device, based at least in part on the detected indication of the relay service which can be provided by the relay communications node, whether to select the relay communications node comprises
determining whether or not to handover from the relay communications node to another communications node if the relay communications node is the source of the handover, or whether or not to handover from the other communications device to the relay communications node if the relay communications node is the target for the handover.

13. A method according to claim 1, wherein the detecting, by the communications device, the indication of the relay service which can be provided by the relay communications node comprises
transmitting, by the communications device, a relay type request to the relay communications node, and in response,
receiving the indication of the relay service from the relay communications node.

14. A method according to claim 1, wherein the detecting, by the communications device, the indication of the relay service which can be provided by the relay communications node comprises
transmitting, by the communications device, a relay type request to an infrastructure equipment which provides a communications cell for the communications device, and in response,
receiving, from the infrastructure equipment which provides the communications cell for the communications device, the indication of the relay service which can be provided by the relay communications node.

15. A method according to claim 1, wherein the detecting, by the communications device, the indication of the relay service which can be provided by the relay communications node comprises
receiving the indication of the relay service which can be provided by the relay communications node from an infrastructure equipment of a wireless communications network.

16. A method according to claim 15, wherein the detecting, by the communications device, the indication of the relay service which can be provided by the relay communications node comprises
receiving an identification of the relay communications node from the infrastructure equipment of the wireless communications network, and
the receiving the indication of the relay service which can be provided by the relay communications node from the infrastructure equipment of the wireless communications network includes receiving the indication of the relay service which can be provided by the relay communications node along with the identification of the relay communications node.

17. A method according to claim 16, the indication of the relay service which can be provided by the relay communications node received along with the identification of the relay communications node is received from the infrastructure equipment as a broadcast signal.

18. A method according to claim 1, comprising
receiving, from a core network, a preferred mapping between one or more communications services and a respective one or more relay services for transmitting data according to the one or more communications services,
identifying a communications service to be used for communicating data to or from the communications device,
determining, based on the preferred mapping received from the core network and the identified communications service to be used for communicating data to or from the communications device, a preferred relay service for communicating the data according to the identified communications service, wherein the determining, by the communications device, based at least in part on the detected indication of the relay service which can be provided by the relay communications node, whether to select the relay communications node comprises
determining whether to select the relay communications node in accordance with whether the relay service which can be provided by the relay communications node is the preferred relay service determined by the communications device.

19.-33. (canceled)

34. A communications node acting as a relay, the communications node comprising
transceiver circuitry configured to transmit and/or to receive signals,
control circuitry configured in combination with the transceiver circuitry to
provide, to a communications device, an indication of a relay service which can be provided by the relay communications node,
receive an indication that the relay communications node has been selected by the communications device, and in response,
provide the relay service to the communications device.

35. An infrastructure equipment comprising
transceiver circuitry configured to transmit and/or to receive signals,
control circuitry configured in combination with the transceiver circuitry to
provide, to a communications device, an indication of a relay service which can be provided by a communications node acting as a relay,
receive, from the communications device, an indication that the relay communications node has been selected by the communications device, and in response,
transmit an indication to the selected relay communications node that the selected relay communications node has been selected by the communications device.

36.-40. (canceled)
